(19) United States
(12) Patent Application Publication
(10) Pub. No.: US 2021/0055267 A1
(43) Pub. Date: Feb. 25, 2021

(54) ARTICLE INSPECTION SYSTEM AND METHOD, ELECTRONIC DEVICE, STORAGE MEDIUM

(71) Applicant: Nuctech Company Limited

(72) Inventors: Qingjun ZHANG, Beijing (CN); Yuanjing LI, Beijing (CN); Zhiqiang CHEN, Beijing (CN); Ziran ZHAO, Beijing (CN); Yinong LIU, Beijing (CN); Yaohong LIU, Beijing (CN); Honghui XIN, Beijing (CN); Biao CAO, Beijing (CN); Nan BAI, Beijing (CN); Qiufeng MA, Beijing (CN)

(73) Assignee: Nuctech Company Limited, Beijing (CN)

(21) Appl. No.: 16/622,553

(22) PCT Filed: May 17, 2019
(86) PCT No.: PCT/CN2019/087484

§ 371 Date: Dec. 13, 2019

(30) Foreign Application Priority Data
Jul. 12, 2018 (CN) 201810761906.3

(51) Int. Cl. G01N 30/02

(52) U.S. Cl. CPC G01N 30/02; G01N 2030/326; G01N 2030/025

(57) ABSTRACT

The present disclosure relates to an article inspection system and method, an electronic device, and a storage medium, and relates to the field of security inspection technology. The system includes: a pre-concentration sampling module configured to concentrate and sample gas molecule of the article under inspection to obtain a sample; a gas chromatography module; an internal circulation gas path module; and an ion migration tube module connected to the internal circulation gas path module and configured to form a fingerprint spectrum of the article under inspection from a spectrum of the pre-separated sample molecules, so as to identify a kind of the article under inspection according to the fingerprint spectrum. The present disclosure improves the efficiency and accuracy of article inspection, and realizes intelligent inspection of articles.

### TECHNICAL FIELD

The present disclosure relates to the field of security inspection technologies, and more particularly, relates to an article inspection system, an article inspection method, an electronic device and a computer readable storage medium.

### BACKGROUND

As quantity of baggage and goods in and out of airports increases, the requirements for security inspections of goods at airports, stations and the like, as well as articles contained in baggage, are gradually increasing.

In order to solve the problem that for a large flow of goods and various kinds of articles, each container has to be inspected at open-package, in the related art, a MOS gas sensor test method has been proposed in the related arts to inspect gas emitted from the article. In addition, a new generation of electronic nose, e.g. ion migration spectrometry (IMS), is configured to inspect articles.

When MOS gas sensors is configured to inspect and identify articles such as meat food and vegetarian food, it is required a high concentration of volatile sample odor under test, and in practice, however, the goods and the articles carried by the passengers have low odor concentrations, and the MOS gas sensors cannot test them quickly. Moreover, when mixed with other complicated volatile odors, the MOS gas sensors may misidentify other goods into articles such as meat food and vegetarian food, thereby causing false inspections. When using MCC-IMS inspection methods to inspect articles such as meat food and vegetarian food, if the volatile odor of these articles is lower than the minimum quantity required by the MCC-IMS instrument to make a response, the instrument cannot obtain a significantly effective signal. Therefore, when the amount of articles such as meat food and vegetarian food is small, error inspection or false inspection may occur.

In addition, a traditional MCC-IMS instrument adopts a gas path with open loop, which causes the gas path of the system to be susceptible to the external environment, which will shorten the life span of the molecular sieve, and even cause a lot of interference spectrum in the spectrum after the molecular sieve is saturated. This leads to a decrease in the accuracy of recognition.

It should be noted that the information disclosed in the Background section above is only for facilitating understanding of the background of the present disclosure, and thus may comprise information that does not constitute prior art known to those of ordinary skill in the art.

### SUMMARY

An objective of the present disclosure is to provide an article inspection system, an article inspection method, an electronic device, and a storage medium, whereby at least to some extent overcoming the at least one problem of low article inspection efficiency, short life span of the molecular sieve, low accuracy and poor control of the system pipe line due to limitations and defects of the related art. In addition, a gas path control system is provided, which can intelligently and quickly realize various complicated functions of the entire inspection system.

Other features and advantages of the present disclosure will be apparent from the following detailed description, or partly learned by the practice of the present disclosure.

According to one aspect of the present disclosure, there is provided an article inspection system, comprising: a pre-concentration sampling module disposed in a preset range from an article under inspection, and is configured to concentrate and sample gas molecules of the article under inspection to capture sample molecules; a gas chromatography module connected to the pre-concentration sampling module and configured to pre-separate the sample molecules; an internal circulation gas path module connected to the gas chromatography module; and an ion migration tube module connected to both the gas chromatography module and the internal circulation gas path module, and configured to inspect a spectrum of the pre-separated sample molecules entering the ion migration tube module from the gas chromatography module, thereby forming a fingerprint spectrum of the article under inspection.

In an exemplary embodiment of the present disclosure, the pre-concentration sampling module comprises: a sampling head configured to sample molecules volatilized from the article under inspection; a solenoid valve configured to control the gas path to be opened or closed; a filler tube configured to adsorb the volatilized molecules; a temperature control component configured to control a temperature of the filler tube; and a sampling pump configured to suction the molecules volatilized from the article under inspection.

In an exemplary embodiment of the present disclosure, the gas chromatography module comprises: a capillary column configured to pre-separate the sample molecules.

In an exemplary embodiment of the present disclosure, the internal circulation gas path module comprises a diaphragm pump configured to provide gas circulation power to the internal circulation gas path; a flow divider configured to divide the gas flow carrying the sample molecules; a buffer module configured to control fluctuations of the gas flow within a preset range; and a molecular sieve module configured to purify the gas flow.

In an exemplary embodiment of the present disclosure, the internal circulation gas path module comprises: an ion migration tube gas path comprising a first molecular sieve module disposed between a second flow divider and the ion migration tube module and a connecting pipe, wherein the gas passes through the ion migration tube gas path and enter a drift gas inlet of the ion migration tube module; a gas chromatography tube gas path comprising a zero gas carrier inlet, a second solenoid valve and a connecting pipe, which are disposed between the second flow divider and the gas chromatography module, wherein the gas enters the gas chromatography module through the gas chromatography tube gas path, and wherein the zero gas carrier inlet is provided with a second molecular sieve module configured to purify the gas to form zero gas; a gas return path comprising a third diaphragm pump and a connecting pipe between the second flow divider and the ion migration tube module, a suction port of the third diaphragm pump facing the ion migration tube, and a gas outlet of the third diaphragm pump facing the second flow divider; and the second flow divider connected to the ion migration tube gas path, the gas chromatography tube gas path and the gas return path.

In an exemplary embodiment of the present disclosure, the ion migration tube gas path further comprises a first buffer module configured to control fluctuation of the gas flow supplied to the ion migration tube module within a preset range; and/or the gas chromatography tube gas path further comprises a second buffer module configured to control fluctuation of the gas flow supplied to the gas chromatography module within a preset range; and/or the gas return path further comprises a third buffer module configured to control fluctuation of the gas flow flowing out of the ion migration tube module within a preset range.

In an exemplary embodiment of the present disclosure, the ion migration tube gas path further comprises a first flow divider disposed between the first molecular sieve module and the ion migration tube module, and the gas passing through the first flow divider to enter a drift gas inlet and/or air carrier inlet of the ion migration tube module.

In an exemplary embodiment of the present disclosure, the gas return path further comprises a third flow divider connected to a discharge port of the ion migration tube module.

In an exemplary embodiment of the present disclosure, the gas chromatography tube gas path further comprises a second diaphragm pump configured to provide additional gas circulation power to the gas chromatography tube gas path.

In an exemplary embodiment of the present disclosure, the gas chromatography tube gas path further comprises a first solenoid valve configured to control the gas path to be opened or closed.

In an exemplary embodiment of the present disclosure, in the ion migration tube gas path, the first buffer module, the first molecular sieve module, and the first flow divider are sequentially arranged in a direction along which the gas moves from the second flow divider to the ion migration tube module, and the gas passes through the ion migration tube gas path to enter the drift gas inlet and the air carrier inlet of the ion migration tube module; in the gas chromatography tube gas path, the second buffer module, the second diaphragm pump, the first solenoid valve, the zero air carrier inlet, and the second solenoid valve are sequentially arranged in a direction along which the gas moves from the second flow divider to the gas chromatography module; and in the gas return path, the third flow divider, the third buffer module, and the third diaphragm pump are sequentially arranged in a direction along which gas moves from the ion migration tube module to the second flow divider.

In an exemplary embodiment of the present disclosure, the ion migration tube module is a migration tube module with positive and negative dual modes, and the migration tube module with positive and negative dual modes comprises: a positive mode ionization zone and a negative mode ionization zone, a positive mode drift zone and a negative mode drift zone, and a positive mode Faraday cup inspection zone and a negative mode Faraday cup inspection zone; wherein the positive mode Faraday cup inspection zone and the negative mode Faraday cup inspection zone are configured to inspect the spectrum of the sample molecules to obtain the fingerprint spectrum of the article under inspection.

According to one aspect of the present disclosure, there is provided an article inspection system, comprising:

an ion migration tube branch comprising a first buffer module, a first molecular sieve module, an ion migration tube, and a connecting pipe therebetween, the connecting pipe configured to guide gas to pass through the first buffer module, the first molecular sieve module, and to enter a drift gas inlet of the ion migration tube module;

a gas chromatography tube branch comprising a second buffer module, a second diaphragm pump, a zero gas carrier gas inlet, a gas sampling inlet, a second solenoid valve, a gas chromatography tube, and a connecting pipe therebetween, the connecting pipe configured to guide carrier gas to pass through the second buffer module, the first solenoid valve, the zero air carrier gas inlet, and to mix with sample gas from the gas sampling inlet, and then to enter the gas chromatography tube through the second solenoid valve, wherein a second molecular sieve module is provided at the zero gas carrier gas inlet;

a gas return branch comprising the third flow divider, the third buffer module, and the third diaphragm pump and a connecting pipe therebetween, wherein under effect of the third diaphragm pump, the gas flows from the ion migration tube module to the third flow divider, the third buffer module, and the third diaphragm pump, and is ultimately suctioned to the second flow divider; and

the second flow divider connected to the ion migration tube branch, the gas chromatography tube gas branch and the gas return branch;

wherein the first buffer module, the second buffer module, and the third buffer module are configured to control fluctuation of gas flow within a preset range, and the first molecular sieve module and the second molecular sieve module are configured to purify the gas to form zero gas, the second flow divider and the third flow divider are configured to divide the gas flow, the first diaphragm pump is configured to provide gas circulation power to the entire system, and the second diaphragm pump is configured to provide additional power to gas flow of gas in the gas chromatography tube branch, and the first solenoid valve and the second solenoid valve are configured to control the gas path to be opened and closed.

In an exemplary embodiment of the present disclosure, the ion migration tube branch further comprises a first flow divider; wherein the gas passes sequentially through the first buffer module, the first molecular sieve module, and the first flow divider and ultimately enters the drift gas inlet and/or the air carrier gas inlet of the ion migration tube module.

In an exemplary embodiment of the present disclosure, the article inspection system further comprises a dynamic pre-concentration sampling branch, and the dynamic pre-concentration sampling branch comprising: a sampling head configured to sample molecules volatilized from an article under inspection; a third solenoid valve configured to control an intake gas path to be opened or closed; a filler tube disposed between the gas sampling inlet of the gas chromatography tube branch and the second solenoid valve and configured to adsorb the volatilized molecules; a temperature control component configured to control a temperature of the filler tube for performing adsorption and desorption operations; a fourth solenoid valve configured to control an exhaust path to be opened or closed; and a first diaphragm pump configured to suction the molecules volatilized from the article under inspection; wherein the dynamic pre-concentration sampling branch is connected to the gas chromatography tube branch through the gas sampling inlet, and an outlet of the filler tube is connected to the second solenoid valve and the fourth solenoid valve.

In an exemplary embodiment of the present disclosure, the gas chromatography tube branch further comprises the first solenoid valve disposed between the second diaphragm pump and the zero gas carrier gas inlet and configured to control the gas path to be opened and closed.

In an exemplary embodiment of the present disclosure, the second flow divider is configured such that a ratio of gas flows to the ion migration tube branch and to the gas chromatography tube branch ranges from 3:1 to 20:1.

According to one aspect of the present disclosure, there is provided an article inspection method, comprising: acquiring sample molecules of an article under inspection; pre-separating the sample molecules of the article under inspection; forming a fingerprint spectrum of the article under inspection according to a spectrum of the sample molecules; and identifying a kind of the article under inspection from the fingerprint spectrum.

In an exemplary embodiment of the present disclosure, identifying the king of the article under inspection from the fingerprint spectrum comprises: identifying the king of the article under inspection according to a mapping relationship between fingerprint spectrums and articles.

In an exemplary embodiment of the present disclosure, acquiring the sample molecules of the article under inspection comprises: performing adsorption treatment on the sample molecules volatilized from the article under inspection by a sampling module, and then heating the sampling module to a preset temperature to perform desorption treatment on the sample molecules.

In an exemplary embodiment of the present disclosure, the sampling module comprises a filler tube, a temperature control component, a sampling pump, a third solenoid valve, and a fourth solenoid valve, during an adsorption process, odor molecules volatilized from the article under inspection are moved by the sampling pump to the third solenoid valve, the filler tube, the fourth solenoid valve, and the sampling pump; after the desorbing, the desorbed sample molecules are suctioned into the gas chromatography module; the volatilized molecules is pre-separated by the gas chromatography module and the pre-separated molecules are introduced into the ion migration tube module; and a spectrum of the molecules is inspected by the ion migration tube module to form the fingerprint spectrum of the article under inspection.

In an exemplary embodiment of the present disclosure, the article inspection method further comprises: after the internal circulation gas path is stabilized, turning on the third solenoid valve, the fourth solenoid valve and the sampling pump, and adjusting the temperature of the filler tube to an adsorption temperature lower than a preset temperature by the temperature control component and directing the sample gas to enter the filler tube under the effect of the sampling pump, performing adsorption treatment on the volatilized molecules by the filler tube, and discharging gas molecules that cannot be adsorbed through a discharge port of the sampling pump; turning off the third solenoid valve, the fourth solenoid valve, and the sampling pump, and then starting a thermal desorption process; turning on the first solenoid valve and the second solenoid valve to direct air to enter the filler tube through a zero gas carrier gas inlet equipped with a second molecular sieve module, and directing a carrier gas containing sample molecules to enter the capillary column of the gas chromatography module from the filler tube, and directing the pre-separated molecules to enter the ion migration tube module through the sample carrier gas inlet; after the molecules are inspected by the ion migration tube module, collecting the molecules from a negative mode outlet and a positive mode outlet of the ion migration module to the third flow divider under effect of the third diaphragm pump, the molecules entering a suction port of the third diaphragm pump through a third buffer module, and being suctioned to a second flow divider ultimately.

In an exemplary embodiment of the present disclosure, after the gas flow containing sample molecules are introduced into the capillary column, the second solenoid valve is turned off, and the sampling pump, the first solenoid valve, and the fourth solenoid valve are turned on for a period to clean the filler tube.

According to one aspect of the present disclosure, there is provided an electronic device, comprising: a processor; and

a memory configured to store executable instructions of the processor;

wherein the processor is configured to perform the article inspection method of any one of the above by executing the executable instructions.

According to one aspect of the present disclosure, there is provided a computer readable storage medium having a computer program stored thereon, wherein the computer program is executed by a processor to implement the article inspection method according to any one of the above.

In an article inspection system, an article inspection method, an electronic device, and a computer readable storage medium provided in an exemplary embodiment of the present disclosure, sample molecules of an article under inspection is acquired by a pre-concentrating sampling module, and the sample molecules are subjected to a pre-separation process by a gas chromatography module. And then a fingerprint spectrum of the article under inspection is obtained through the ion migration tube module to identify a kind of the article under inspection rapidly according to the fingerprint spectrum. On one hand, the kind of the article under inspection can be quickly identified by according to fingerprint spectrum, and the inspection efficiency is improved; and moreover, concentration of the sample molecules of the article under inspection is improved by sampling and concentrating the sample molecules, such that the fingerprint spectrum of the article under inspection can be easily obtained and the occurrence of missed inspection and false inspection in case of few article carried can be avoided, whereby improving the accuracy of article inspection. On the other hand, by means of such an article inspection system in which a plurality of diaphragm pumps, a plurality of solenoid valves, a ion migration tube, a gas chromatography module and a pre-concentration sampling module are combined together, a various functions can be achieved by controlling the diaphragm pumps and the solenoid valves, such that functions modules such as the pre-concentration sampling module and the like can perform their respective functions without being moved. Thus, convenience for the article inspection can be improved and articles can be inspected in a more intelligent manner.

It should be understood that, the above general description and the following detailed description are intended to be illustrative and explanatory, and cannot be construed as a limit to the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure. Apparently, the drawings in the following description are merely some of the embodiments of the present disclosure, and those skilled in the art can obtain other drawings based on these drawings without any creative effort.

FIG. 1 is a block diagram schematically illustrating an article inspection system according to an exemplary embodiment of the present disclosure;

FIG. 2 is a diagram schematically illustrating a specific configuration of an article inspection system according to an exemplary embodiment of the present disclosure;

FIG. 3 is a schematic block diagram illustrating a simplified structure of an article inspection system according to an exemplary embodiment of the present disclosure;

FIG. 4 is a flow chart schematically illustrating an article inspection method according to an exemplary embodiment of the present disclosure;

FIG. 5 is a flow chart schematically illustrating an article inspection method according to an exemplary embodiment of the present disclosure;

FIG. 6 is a schematic diagram illustrating a first fingerprint spectrum according to an exemplary embodiment of the present disclosure;

FIG. 7 is a schematic diagram illustrating a second fingerprint spectrum according to an exemplary embodiment of the present disclosure;

FIG. 8 is a schematic diagram illustrating a third fingerprint spectrum according to an exemplary embodiment of the present disclosure;

FIG. 9 is a schematic diagram illustrating a fourth fingerprint spectrum according to an exemplary embodiment of the present disclosure;

FIG. 10 is a block diagram schematically illustrating an electronic device according to an exemplary embodiment of the present disclosure; and

FIG. 11 schematically illustrates a program product according to an exemplary embodiment of the present disclosure.

### DETAILED DESCRIPTION

Example embodiments will now be described more fully with reference to the accompanying drawings. However, the example embodiments can be embodied in a variety of forms and should not be construed as being limited to the examples set forth herein; rather, these embodiments are provided so that this disclosure will be more thorough and complete, and concept of exemplary embodiments can be fully conveyed to those skilled in the art. The described features, structures, or characteristics may be combined in one or more embodiments in any suitable manner. In the following description, numerous specific details are set forth to enable thorough understanding of the embodiments of the present disclosure. However, one skilled in the art will appreciate that one or more of the specific details may be omitted or other methods, components, devices, steps, etc. may be employed. In other instances, various aspects of the present disclosure will not be described in detail to avoid obscuring the aspects of the present disclosure.

In addition, the drawings are merely schematic representations of the present disclosure and are not necessarily drawn to scale. The same reference numerals in the drawings indicate the same or similar parts, and the repeated description thereof will be omitted. Some of the block diagrams illustrated in the figures are functional entities and do not necessarily have to correspond to separately physical or logical entities. These functional entities can be implemented in software, or implemented in one or more hardware modules or integrated circuits, or implemented in different networks and/or processor devices and/or microcontroller devices.

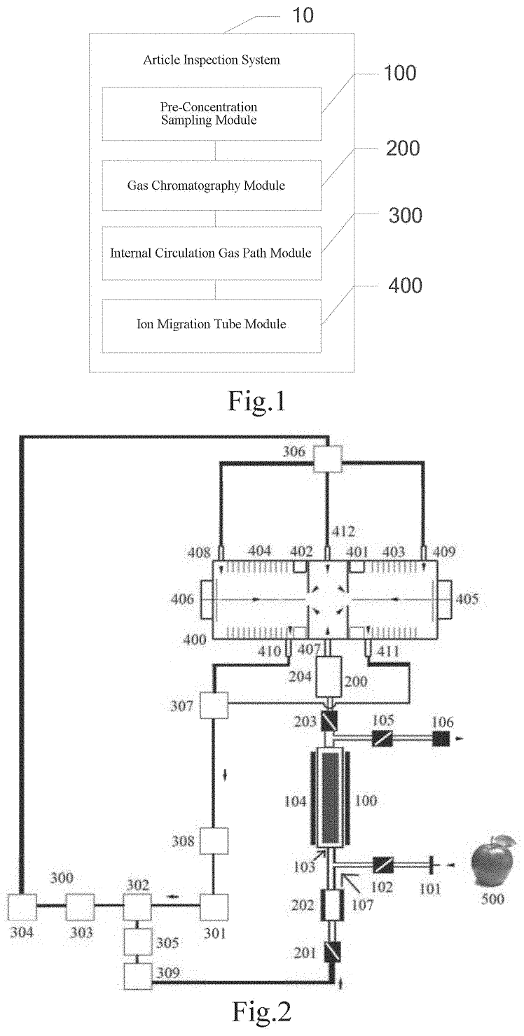

In the present exemplary embodiment, an article inspection system 10 is first provided, which is be applicable to any place that requires security inspection, such as airports, stations, and the like, to provide inspection basis such as a fingerprint spectrum and the like to the user through the article inspection system, in order to achieve the purpose of accurate inspection of articles. Referring to FIG. 1, the article inspection system 10 may specifically comprise a pre-concentration sampling module 100, a gas chromatography module 200, an internal circulation gas path module 300, and an ion migration tube module 400.

The pre-concentration sampling module 100 is disposed in a preset range from an article under inspection, and is configured to sample and concentrate gas molecules of the article under inspection to capture sample molecules.

The gas chromatography module 200 is connected to the pre-concentration sampling module and configured to pre-separate the sample molecules.

The internal circulation gas path module 300 is connected to the gas chromatography module and the ion migration tube module.

The ion migration tube module 400 is connected to the gas chromatography module and the internal circulation gas path module, and configured to detect a spectrum of sample molecules that is pre-separated and enters the ion migration tube module from the gas chromatography module, thereby forming a fingerprint spectrum of the article under inspection.

In the article inspection system provided by the exemplary embodiment, on one hand, by quickly identifying a kind of the article under inspection according to the fingerprint spectrum, the inspection efficiency can be improved. And moreover, by concentrating and sampling the sample molecules, the concentration of the sample molecules of the article under inspection can be increased, which not only can make it easier to inspect the fingerprint spectrum of the article, but further can avoid missing inspection and false inspection when the quantity of the article is small, and further can improve the accuracy of article inspection. On the other hand, through such an article inspection system with a plurality of diaphragm pumps, a plurality of solenoid valves which cooperates with the ion migration tube, the gas chromatography module and the pre-concentration sampling module, various functions can be achieved by controlling the diaphragm pumps and solenoid valves, and the modules such as the pre-concentration sampling module can be dynamically changed without being moved, thereby improving the convenience of article inspection.

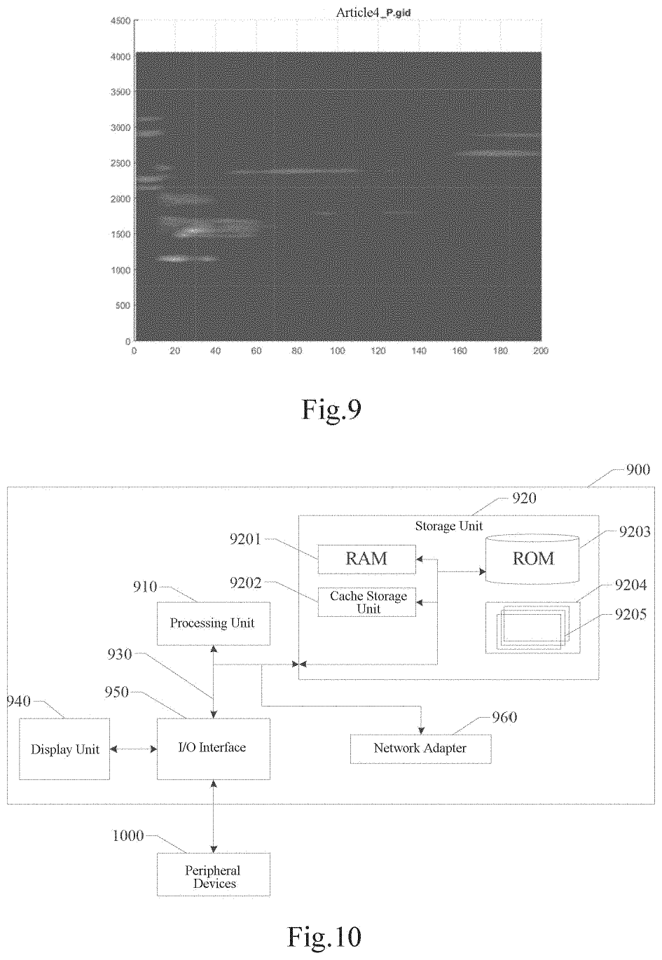

Next, a specific portion of the article inspection system will be specifically described with reference to FIGS. 1 to 9.

The pre-concentration sampling module 100 is disposed in a preset range from an article under inspection, and is configured to concentrate and sample gas molecules of the article under inspection to capture sample molecules.

In the exemplary embodiment, the article under inspection may be of any shape, any size, any kind of animal, plant, or food, etc., and food is taken as an example of the article under inspection for description. The article under inspection can be placed alone at the sampling site or in a suitcase, a container or other vessel. The article under inspection can be completely placed at the sampling site of the pre-concentration sampling module, or the under inspection can be processed by chopping, beating, bottling, filling, fresh-keeping with bags, etc., and then placed at the sampling site. The form of the article under inspection is not specifically limited in the example.

The preset range can be set according to actual safety inspection requirements. For example, it can be within 0.5 meter around the article under inspection, or can be set to other values, such as within 1 meter around the article under inspection. Generally, the article under inspection will volatilize gas molecules with a relatively low concentration, and the gas molecules of each article are different, so the article can be inspected based on the gas molecules to identify the kind of the article under inspection.

In this example, by concentrating and sampling naturally volatilized gas molecules, sample molecules with a relatively low concentration can be captured, and the problem that the instrument cannot generate a significant signal due to a lower concentration can be avoided, so that even the quantity of the article under inspection which is carried by the user is small, it is further possible to capture enough sample molecules by concentrating and sampling to effectively inspect the article under inspection.

Specifically, referring to FIG. 2, the pre-concentration sampling module 100 can comprise: a sampling head 101, a third solenoid valve 102, a filler tube 103, a temperature control component 104, a fourth solenoid valve 105, and a first diaphragm pump (sampling pump) 106. The sampling head 101 is configured to sample gas molecules volatilized from an article 500 under inspection. The third solenoid valve 102 and the fourth solenoid valve 105 are configured to control the gas path to be opened or closed. The filler tube 103 is disposed between a gas sampling inlet 107 and a second solenoid valve 203 in a branch of the gas chromatography tube and configured to adsorb gas molecules. The temperature control component 104 is disposed around the filler tube 103 and configured to control the temperature of the filler tube for performing adsorption and desorption operation. The first diaphragm pump (sampling pump) 106 is configured to control the gas path to be opened or closed. A dynamic pre-concentration sampling branch is connected to the branch of the gas chromatography tube through the gas sampling inlet 107, and an outlet of the filler tube 103 is connected to the second solenoid valve 203 and the fourth solenoid valve 105.

The filler in the filler tube 103 can be filler such as Tenaxs TA, Tenaxs GR, Carbotrap, and Carboxen 569 and the like, or a mixture of Tenax and an activated carbon filler to adsorb and trap gas molecules volatilized from the article 500 under inspection. At the same time, gas molecules that cannot be adsorbed and trapped are discharged into the atmosphere. It should be noted that the filler tube 103 can be configured to adsorb trapped gas molecules for 1 to 3 seconds. The temperature control component 104 can implement a cooling and heating function so as to control the temperature of the filler tube to a preset temperature. The preset temperature can be set according to different stages, which can be set to 10-20 degrees Celsius during the sampling phase and 100-150 degrees Celsius during the pre-separation phase.

Referring again to FIG. 2, the gas chromatography module 200 can comprise a first solenoid valve 201, a second solenoid valve 203, a zero gas carrier gas inlet 202, and a capillary column 204. The first solenoid valve 201 and the second solenoid valve 203 are configured to control the gas path to be opened or closed. The capillary column 204 is configured to separate the sample molecules; and the zero gas carrier gas inlet 202 is configured to purify the gas to form zero gas.

In general, zero gas is a gas produced by filtering ordinary air through a multi-layer molecular sieve. The inner surface of the capillary column is coated with a polarity layer to pre-separate sample molecules with different polarities through a capillary column.

Referring to FIG. 2 again, the internal circulation gas path module 300 can comprise: a third diaphragm pump 301, a second diaphragm pump 309, a second flow divider 302, a first flow divider 306 and a third flow divider 307 which are configured for dividing gas flow, a first buffer module 303, a second buffer module 305, a third buffer module 308, and a first molecular sieve module 304. The diaphragm pump is configured to control the gas path to be opened or closed. The reason for further providing a second diaphragm pump 309 in addition to the third diaphragm pump 301 is that the pre-concentration sampling module 100 is comprised in the sampling branch to which the second diaphragm pump 309 belongs, and the filler tube 103 has a large gas resistance, so it is preferable to further provide a second diaphragm pump 309 for pressurization. The flow dividers are configured to divide the gas flow carrying the sample molecules to the gas chromatography module and the ion migration tube module. The buffer modules are configured to control fluctuations of the gas flow carrying the sample molecules within a predetermined range; and a molecular sieve module is configured to purify the gas flow carrying sample molecules.

The flow divider can comprise a three-way or a four-way divider. In this example, the second flow divider 302 and the third flow divider 307 are three-way dividers, and the second flow divider 306 is a four-way divider. The preset range of all the buffer modules for controlling the fluctuation can be 5-10 ml/min so as to control the flow fluctuation of the gas flow supplied to the ion migration tube module 400 within 5-10 ml/min by means of the buffer module, thereby stabilizing the gas flow. Further, the first molecular sieve module 304 can form zero gas by removing water vapor, organic gas molecules, and the like in the gas from the stabilized gas flow. Through the internal circulation gas path module, a closed loop of the entire zero gas system can be realized, and interference from the external environment can be reduced.

It should be noted that the internal circulation gas path module illustrated in FIG. 2 can specifically comprise three gas paths: an ion migration tube gas path, comprising the first molecular sieve module 304 disposed between the second flow divider 302 and the ion migration tube module 400 and a connecting pipe, and gas passes through the ion migration tube gas path and enters a drift gas inlet of the ion migration tube module 400. In addition, the ion migration tube gas path further comprises the first buffer module 303 configured to control the fluctuation of the gas flow within a preset range. The ion migration tube gas path further comprises the first flow divider 306 disposed between the first molecular sieve module 304 and the ion migration tube module 400, and the gas passes through the first flow divider 306 and enters a positive mode drift gas inlet 409 and a negative mode drift gas inlet 408 of the ion migration tube module 400 through. If the ion migration tube module 400 is further provided with an air carrier gas inlet 412, the gas passes through the first flow divider 306 and then further enters the air carrier gas inlet 412.

In FIG. 2, the first buffer module 303, the first molecular sieve module 304, and the first flow divider 306 are arranged sequentially according in the direction along which the gas moves from the second flow divider 302 to the ion migration tube, and the gas enters the drift gas inlet and the air carrier gas inlet of the ion migration tube module through the ion migration tube gas path. However, the arrangement orders of the first buffer module 303 and the first molecular sieve module 304 can be interchanged.

A gas chromatography tube gas path comprises the zero gas carrier gas inlet 202, the second solenoid valve 203, and a connecting pipe, which are disposed between the second flow divider 302 and the gas chromatography module 200, and the gas enters the gas chromatography module 200 through the gas chromatography tube gas path. A second molecular sieve module is provided at the zero gas carrier gas inlet 202 for purifying the gas to form zero gas. The gas chromatography tube gas path further comprises the second buffer module 305 configured to control the fluctuation of the gas flow within a preset range. The gas chromatography tube gas path further comprises the second diaphragm pump 309 configured to provide additional gas circulation power to the gas chromatography tube gas path. The gas chromatography tube gas path further comprises the first solenoid valve 201 configured to control the gas path to be opened or closed.

In the gas chromatography tube gas path illustrated in FIG. 2, the second buffer module 305, the second diaphragm pump 309, the first solenoid valve 201, the zero air carrier gas inlet 202, and the second solenoid valve 203 are arranged sequentially in the direction along which the gas moves from the second flow divider to the gas chromatography module. However, the arrangement orders of the second buffer module 305 and the second diaphragm pump 309 can be interchanged.

A gas return path comprises the third diaphragm pump 301 and a connecting pipe which are disposed between the second flow divider 302 and the ion migration tube module 400, a suction port of the third diaphragm pump 301 is connected to the ion migration tube module, and the gas outlet is connected to the second flow divider 302; and the second flow divider 302 is connected to the ion migration tube gas path, the gas chromatography tube gas path and the gas return path. The gas return path further comprises the third buffer module 308 configured to control the fluctuation of the gas flow within a preset range. The gas return path further comprises the third flow divider 307 connected to the discharge port of the ion migration tube module.

With continued reference to FIG. 2, the ion migration tube module 400 can preferably be a positive and negative dual modes migration tube module that can detect many kinds of contraband such as drugs and explosives. However, the positive and negative dual modes migration tube module is only a preferred embodiment of the present application, and any one of a positive mode ion migration tube module or a negative mode ion migration tube module can be adopted in the present application. Specifically, the positive and negative dual modes migration tube module comprises: a positive mode ionization zone 401 and a negative mode ionization zone 402, a positive mode drift zone 403 and a negative mode drift zone 404, a positive mode Faraday cup inspection zone 405, and a negative mode Faraday cup inspection zone 406. The positive mode Faraday cup inspection zone and the negative mode Faraday cup inspection zone are configured to inspect the spectrum of the sample molecules to obtain a fingerprint spectrum. In addition, the ion migration tube module 400 can further comprise a gas path portion. The gas path portion is mainly composed of a positive mode drift gas inlet 409, a positive mode drift gas discharge port 411, a negative mode drift gas inlet 408, and a negative mode drift gas discharge port 410, a sample carrier gas inlet 407, and an air carrier gas inlet 412.

Positive mode refers to applying a positive voltage at a positive mode migration tube terminal, by which a first type of articles such as drugs can be detected. Negative mode refers to applying a positive voltage at the migration tube terminal, by which a first type of articles such as explosion samples can be detected. Through the positive and negative dual modes migration tube, various molecules with positive and negative ion affinity can be detected, and the inspection range can be expanded, thereby avoiding the missed inspection. The fingerprint spectrum of the sample under inspection is obtained from the spectrum of the sample molecules obtained by the positive and negative dual modes Faraday cup inspection zone. Since fingerprint spectrum corresponding to each kind of articles is different, a kind of each article under inspection can be identified according to a mapping relationship between fingerprint spectrums and articles.

Based on the above gas paths, the article inspection system can further comprise the following branches: 1. an ion migration tube branch comprising the first buffer module 303, the first molecular sieve module 304, an ion migration tube, and a connecting pipe therebetween, the ion migration tube branch configured to guide gas to pass through the first buffer module 303, the first molecular sieve module 304, and to enter the drift gas inlet of the ion migration tube module 400, such as a positive mode drift gas inlet 409 and a negative mode drift gas inlet 408. The ion migration tube branch further comprises the first flow divider 306, and gas sequentially passes through the first buffer module 303, the first molecular sieve module 304, the first flow divider 306, and ultimately enters the positive mode drift gas inlet 409, the negative mode drift gas inlet 408 and/or the air carrier gas inlet 412 of the ion migration tube module.

A gas chromatography tube branch comprises the second buffer module 305, the second diaphragm pump 309, the zero gas carrier gas inlet 202, the gas sampling inlet 107, the second solenoid valve 203, the gas chromatography tube, and a connecting pipe therebetween, and the gas chromatography tube branch is configured to guide carrier gas to pass through the second buffer module 305, the first solenoid valve 201, the zero air carrier gas inlet 202, and to mix with sample gas from the gas sampling inlet 107, and then to enter the gas chromatography tube through the second solenoid valve 203, wherein a second molecular sieve module is provided at the zero gas carrier gas inlet. The gas chromatography tube branch further comprises the first solenoid valve 201 disposed between the second diaphragm pump 309 and the zero gas carrier gas inlet 202 and configured to control the gas path to be opened or closed.

A gas return branch comprises the third flow divider 307, the third buffer module 308, the third diaphragm pump 301, and a connecting pipe therebetween. Under the effect of the third diaphragm pump 301, gas flows from the ion migration tube module 400 and moves to the third flow divider 307, the third buffer module 308, and the third diaphragm pump 301, and is suctioned to the second flow divider 302 ultimately.

The second flow divider 302 is connected to the ion migration tube branch, the gas chromatography tube branch and the gas return branch, and the second flow divider 302 is configured to make the ratio of gas flows entering the ion migration tube branch and the gas chromatography tube branch to be in a range from 3:1 to 20:1.

The dynamic pre-concentration sampling branch comprises a sampling head 101 configured to sample molecules volatilized from the article 500 under inspection; the third solenoid valve 102 configured to control the intake gas path to be opened or closed; and a filler tube 103 located between the gas sampling inlet 107 of the gas chromatography tube branch and the second solenoid valve 203 and configured to adsorb volatilized molecules; the temperature control component 104 configured to control a temperature of the filler tube for performing adsorption and desorption operation; the fourth solenoid valve 105 configured to control the outlet gas path to be opened or closed; and the first diaphragm pump (sampling pump) 106 configured to suction molecules volatilized from the article 500 under inspection; wherein the concentrated sampling branch is connected to the gas chromatography tube branch through a gas sampling inlet, and the outlet of the filler tube 103 is connected to the second solenoid valve 203 and the fourth solenoid valve 105.

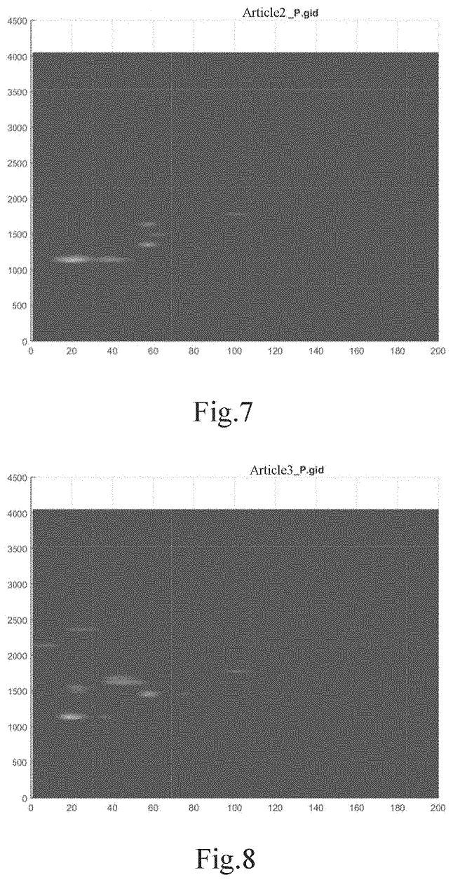

Before the article is inspected, the fingerprint spectrums of all kinds of articles can be stored in a database of the article inspection system in advance, and it is further programmed to compare the obtained fingerprint spectrums with the fingerprint spectrums of all kinds of articles in the database to obtain the most matching fingerprint spectrum, and in turn to identify the type or type of article under inspection. For example, if the obtained fingerprint spectrum is as illustrated in FIG. 7, it can be determined that the article under inspection is an article 2 (for example, Luzhou Chenqu wine) by matching with the fingerprint spectrums of all kinds of articles stored in the database. If the obtained fingerprint spectrum is as illustrated in FIG. 8, it can be determined that the article under inspection is an article 3 (for example, beef jerky) by matching with the fingerprint spectrums of all kinds of articles stored in the database.

By extracting the fingerprint spectrum of the sample molecules through the ion migration tube module 400, the kind of the article under inspection can be quickly identified, thereby improving the article inspection efficiency, and offering convenience for security inspection in places with a large traffic and with a large number of articles such as airports, stations, and the like. In addition, the article inspection accuracy can be improved even where the number of articles is relatively large.

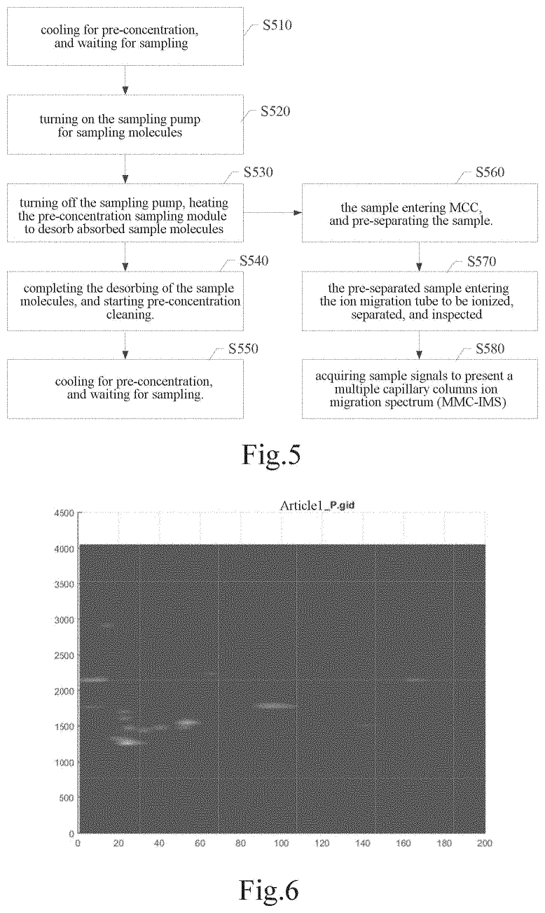

The specific process of inspecting an article will be specifically described with reference to the specific structural diagram illustrated in FIG. 2 and the flowcharts illustrated in FIGS. 4 and 5.

First, the zero gas system is tested to ensure that the zero gas system is a closed loop. At the beginning of the test, the third diaphragm pump 301 and the second diaphragm pump 309 in the internal circulation gas path module 300 are turned on, and the output rate of gas flow is controlled to be 1 L to 1.5 L per minute to supply air to the entire closed circulating gas path system. The gas flow is conveyed to the second flow divider 302 for dividing gas flow, one portion of the gas flow is supplied to the gas chromatography module 200, and the other portion of the gas flow is supplied to the ion migration tube module 400, and the ratio of the two portions can be adjusted to between 12:1 and 6:1.

The other portion of gas flow supplied to the ion migration tube module 400 passes through the first buffer module 303 to stabilize the gas flow, and the fluctuation is controlled within 5-10 ml/min. The stabilized gas flow is subject to the first molecular sieve module 304 to remove water vapor and organic gas molecules in the air to form zero gas. The purified zero gas distributes zero gas through the first flow divider 306 to the negative mode drift gas inlet 408, the air carrier gas inlet 412, and the positive mode drift gas inlet 409. After passing through the migration tube, the gas from the negative mode discharge port 410 and the positive mode discharge port 411 is collected at the third flow divider 307, then the gas passes through the third buffer module 308, and ultimately flows back to the suction port of the third diaphragm pump 301.

The portion of gas flow supplied to the gas chromatography module 200 flows through the second buffer module 305 and arrives at the suction port of the second diaphragm pump 309, and the outlet of the second diaphragm pump 309 delivers the portion of gas flow to the first solenoid valve 201. Then, the gas flow passes through the zero gas carrier gas inlet 202 to remove the water vapor and the organic gas molecules in the air so as to form zero gas. After that, the gas flow is injected into the filler tube 103 filled with pre-concentration filler, and then passes through the second electromagnetic valve 203 such that the gas flow carrying sample molecular flows through the capillary column 204 coated with the polarity layer to be separated, and ultimately flows into the sample carrier gas inlet 407 to achieve a closed circulating of the zero gas system.

After the closed circulating zero gas system is stabilized, the article 500 under inspection is placed at the front end of or within a preset range of the sampling head 101 with filter membrane, and the temperature control component 104 is turned on to cool the filler tube 103 filled with the Tenax-TA filler to 10-20 degrees Celsius. After the temperature is stabilized, the first solenoid valve 201 and the second solenoid valve 203 that control the gas path to be opened or closed are turned off, the third solenoid valve 102 and the fourth solenoid valve 105 are turned on, and the first diaphragm pump (sampling pump) 106 is turned on to control the gas flow rate within a range of 400 ml/min to 800 ml/min. The gas volatilized from the sample 500 is sucked into the filler tube 103 filled with the Tenax-TA filler through the sampling head 101, and at this time, the filler tube starts to adsorb and trap the gas molecules volatilized from the article 500 under inspection for 1 to 3 seconds to form sample molecules, and gas molecules that cannot be adsorbed are discharged to the atmosphere through the discharge port of the first diaphragm pump (sampling pump) 106. After the gas molecules are adsorbed and trapped, the third solenoid valve 102 and the third solenoid valve 105 can be turned off, the first diaphragm pump (sampling pump) 106 is turned off, and the sampling process on the article 500 under inspection ends.

After the sampling process is completed, the temperature control component 104 can be turned on again to instantaneously heat the filler tube 103 to 100° C.-150° C. to perform rapid thermal desorption treatment on the collected sample molecules of the article 500 under inspection. The first solenoid valve 201 and the second solenoid valve 203 are turned on again, so that air having a gas flow rate of 80 ml/min to 200 ml/min enters the filler tube 103 through the zero gas carrier gas inlet 202 filled with the molecular sieve to obtain a gas flow with sample molecules. The gas flow is pre-separated by a capillary column 204 coated with a polarity layer. The pre-separated gas flow is transported to the ion migration tube module 400 through the sample carrier gas inlet 407 such that the ion migration tube module 400 inspects the spectrum of the sample molecules pre-separated by the capillary column 204, thereby forming an MCC-IMS fingerprint spectrum of the article 500 under inspection.

After the gas flow containing the sample molecules enters the capillary column 204, the second solenoid valve 203 is turned off, and the first diaphragm pump (sampling pump) 106, the first solenoid valve 201 and the fourth solenoid valve 105 are turned on for a period to clean the filler tube 103. Of course, according to another embodiment of the present application, the operation of cleaning the filler tube 103 can further be performed after forming the fingerprint spectrum, but in this case, the operating time of the entire system will be slightly elongated.

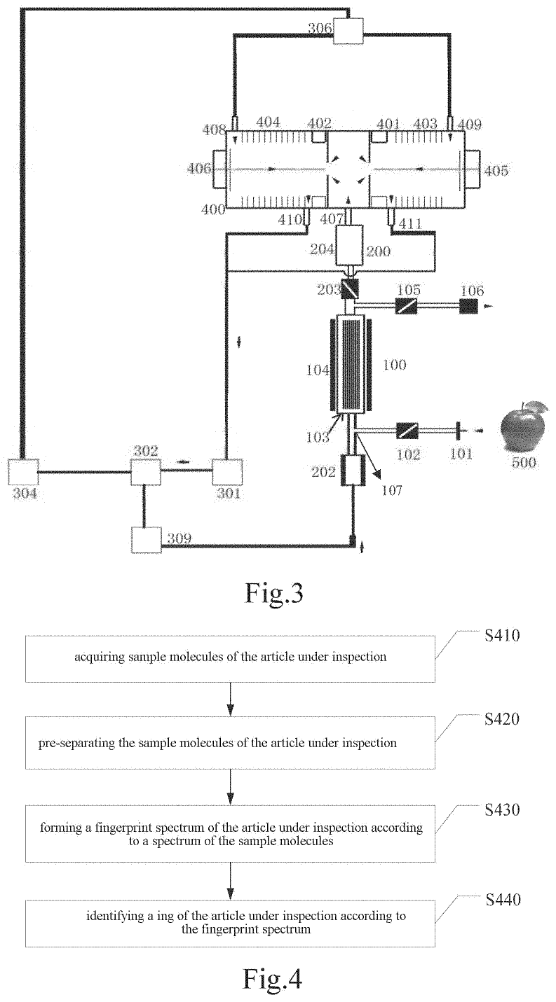

It should be noted that the respective solenoid valves, diaphragm pumps, buffer modules, molecular sieve modules, and respective connecting pipes in FIG. 2 are the preferred embodiments of the present application, but the present application is not limited thereto, and the devices in the gas path can be simplified, and a schematic diagram of the simplified structure can be illustrated in FIG. 3, and can even be further simplified on the basis of FIG. 3. It should be noted that, for the ion migration tube gas path, the air carrier gas inlet 412 and the first buffer module 303 can be omitted to simplify the system. If the ion migration tube is not provided with the air carrier gas inlet 412, the first flow divider 306 can be a three-way divider, and the gas flow is only conveyed into the positive mode drift gas inlet 409 and the negative mode drift gas inlet 408. Further, if the ion migration tube is a single mode migration tube, the first flow divider 306 can be omitted. If the first buffer module 303 is omitted, the gas flow will not be stable enough, but the same objective can be achieved.

For the gas chromatography tube gas path, the second buffer module 305 can be omitted, and the same objective can be achieved, even though the gas flow is less stable. The first solenoid valve 201 can further be omitted, but this omitting will result in inconvenience in control or difficulty in controlling the gas flow. The second diaphragm pump 309 can be barely omitted, but this will increase the burden of the third diaphragm pump 301, and it is difficult to achieve the effect.

For the gas return path, if the ion migration tube is a single mode ion migration tube, there is only one discharge port, for example, the negative mode discharge port 410, so the third flow divider 307 can further be omitted. In addition, the third buffer module 308 can be omitted, and with such omission, the gas flow will be less stable, which is not most preferable.

Based on the gas paths and the branches provided above, an exemplary article inspection method is further provided in an exemplary embodiment. Referring to FIG. 4, the method can specifically comprise the following steps.

In step S410, acquiring sample molecules of the article under inspection.

In step S420, pre-separating the sample molecules of the article under inspection.

In step S430, forming a fingerprint spectrum of the article under inspection according to the spectrum of the sample molecules.

In step S440, identifying a kind of the article under inspection according to the fingerprint spectrum.

Wherein, in step S420, the sample molecules of the article under inspection are pre-separated by means of a capillary column coated with a polarity layer.

Identifying the kind of the article under inspection according to the fingerprint spectrum in the step S440 comprises: identifying a kind of the article under inspection according to a mapping relationship between fingerprint spectrums and articles.

In addition to the above, the method further comprises: performing a thermal desorption treatment on the sample molecules by heating the sample molecules to a predetermined temperature. The preset temperature can be, for example, 100 to 150 degrees Celsius.

It should be noted that the specific details of each step in the above-mentioned article inspection method have been described in detail in the corresponding article inspection system, and thus will not be elaborated herein.

The article inspection process will be specifically described in conjunction with the gas paths and branches described above. First, the molecules volatilized from the article 500 under inspection are sampled by the sampling head 101, and under the effect of the first diaphragm pump (sampling pump) 106, the gas is directed to the third solenoid valve 102, the filler tube 103, and the temperature control component 104, the fourth solenoid valve 105 and the first diaphragm pump (sampling pump) 106 and enters the gas chromatography module 200. Specifically, the molecules volatilized from the article 500 under inspection are sampled by the sampling head 101, and the gas enters the filler tube 103 controlled by the temperature control component 104 under the effect of the third solenoid valve 102 to adsorb the volatilized molecules. The molecules that are volatilized from the article under inspection are sucked by the first diaphragm pump (sampling pump) 106 under the effect of the fourth solenoid valve 105.

Next, the volatilized molecules are pre-separated by the gas chromatography module 200 and the pre-separated molecules are introduced into the ion migration tube module 400. Specifically, under the effect of the first solenoid valve 201 and the second solenoid valve 203, air is introduced into the filler tube 103 through the zero gas carrier gas inlet 202 provided with the second molecular sieve module, and the carrier gas of the molecules of the article under inspection is introduced from the filler tube 103 into the capillary column 204 to be pre-separated, and the pre-separated molecules pass through the sample carrier gas inlet 407 and enter the ion migration tube module 400.

Finally, the ion migration tube module 400 is configured to inspect the spectrum of the molecules to form a fingerprint spectrum of the article under inspection. After the molecules are inspected by the ion migration tube module 400, the molecules are collected from the negative mode discharge port 410 and the positive mode discharge port 411 of the ion migration module to the third flow divider 307 under effect of the third diaphragm pump 301. And then, the molecules pass through the third buffer module 308 and enter the suction port of the third diaphragm pump 301 and are ultimately suctioned to the second flow divider 302.

Next, the molecules are circulated through the ion migration tube branch, the gas chromatography tube branch, and the gas return branch to inspect the gas volatilized from the article under inspection.

FIG. 5 illustrates a specific flow chart of article inspection, specifically comprising the following steps.

In step S510, cooling for pre-concentration, and waiting for sampling.

In step S520, turning on the first diaphragm pump (sampling pump) 106 for sampling molecules.

In step S530, turning off the sampling pump 106, heating the pre-concentration sampling module to desorb absorbed sample molecules. After step S530, steps S540 and S550 may be continued, and steps S560 to S580 are performed for subsequent inspection.

In step S540, the desorbing of the sample molecules ends, and starting pre-concentration cleaning.

In step S550, cooling for pre-concentration, and waiting for sampling.

In step S560, the sample entering multiple capillary columns (MCC), and pre-separating the sample.

In step S570, the pre-separated sample entering the ion migration tube to be ionized, separated, and inspected.

In step S580, acquiring sample signals to present a multiple capillary columns ion migration spectrum (MMC-IMS). And then, a kind of article under inspection can be identified according to the MCC-IMS spectrum.

It should be noted that although several modules or units of equipment for function execution are mentioned in the detailed description above, such division is not mandatory. Indeed, in accordance with embodiments of the present disclosure, the features and functions of two or more modules or units described above can be embodied in one module or unit. Conversely, the features and functions of one of the modules or units described above can be further divided into multiple modules or units.

In addition, although the various steps of the method of the present disclosure are described in a particular order in the drawings, it is not suggested or implied that the steps must be performed in the specific order, or all the steps illustrated must be performed to achieve the desired result. Additionally or alternatively, omitting certain steps, combining multiple steps into one step, and/or dividing one step into multiple steps and the like are also possible.

In an exemplary embodiment of the present disclosure, an electronic device capable of implementing the above method is further provided.

Those skilled in the art will appreciate that various aspects of the present disclosure can be implemented as a system, a method, or a program product. Therefore, various aspects of the present disclosure can be embodied in the form of a complete hardware implementation, a complete software implementation (comprising firmware, microcode, etc.), or a combination of hardware and software, which may be collectively referred to herein as “circuit”, “module”, or “system”.

An electronic device 900 in accordance with such an embodiment of the present disclosure is described below with reference to FIG. 10. The electronic device 900 illustrated in FIG. 10 is merely an example and should not be construed as a limit on the function and scope of use of the embodiments of the present disclosure.

As illustrated in FIG. 10, the electronic device 900 is embodied in the form of a general purpose computing device. The components of the electronic device 900 can comprise, but are not limited to, at least one processing unit 910, at least one storage unit 920, and a bus 930 that connects different system components (comprising the storage unit 920 and the processing unit 910).

Wherein, the storage unit stores program codes, which can be executed by the processing unit 910, such that the processing unit 910 performs the steps of various exemplary embodiments according to the present disclosure described in the “Exemplary Method” section of the present specification. For example, the processing unit 910 can perform the steps as illustrated in FIG. 4.

The storage unit 920 can comprise a readable medium in the form of a volatile storage unit, such as a random access storage unit (RAM) 9201 and/or a cache storage unit 9202, and can further comprise a read only storage unit (ROM) 9203.

The storage unit 920 can further comprise a program/utility tool 9204 having a set (at least one) of the program modules 9205, such as but not limited to: an operating system, one or more applications, other program modules, and program data. Each or combination of the examples can comprise implementations of the network environment.

The bus 930 can represent one or more of several types of bus structures, and can comprise a memory unit bus or a memory unit controller, a peripheral bus, a graphics acceleration port, a processing unit, or a local area bus adopting any of a variety of bus structures.

The electronic device 900 can further communicate with one or more peripheral devices 1000 (e.g., a keyboard, a pointing device, a Bluetooth device, etc.), and can further communicate with one or more devices that enable the user to interact with the electronic device 900, and/or communicate with any device that enables the electronic device 900 to communicate with one or more devices (e.g., routers, modems, etc.). This communication can take place via an input/output (I/O) interface 950. Further, the electronic device 900 can communicate with one or more networks (e.g., a local area network (LAN), a wide area network (WAN), and/or a public network, such as the Internet) through a network adapter 960. As illustrated, the network adapter 960 communicates with other modules of the electronic device 900 via the bus 930. It should be understood that although not illustrated in the figures, other hardware and/or software modules can be utilized in conjunction with the electronic device 900, comprising but not limited to: microcodes, device drivers, redundant processing units, external disk drive arrays, RAID systems, tape drivers and data backup storage systems, etc.

Through the description of the above embodiments, those skilled in the art will readily understand that the example embodiments described herein may be implemented by software or by software in combination with necessary hardware. Therefore, the technical solution according to an embodiment of the present disclosure can be embodied in the form of a software product, which can be stored in a non-volatile storage medium (which may be a CD-ROM, a USB flash drive, a mobile hard disk, etc.) or on a network. A number of instructions are comprised to cause a computing device (which may be a personal computer, a server, a terminal device, or a network device, etc.) to perform the methods in accordance with the embodiments of the present disclosure.

In an exemplary embodiment of the present disclosure, there is further provided a computer readable storage medium having a program product stored thereon, the program product capable of implementing the above method of the present specification. In some possible implementations, aspects of the present disclosure may further be embodied in the form of a program product comprising program codes causing said program product to run on a terminal device, such that the terminal device performs the steps according to various exemplary embodiments of the present disclosure described in the “Exemplary Method” section of the present specification.

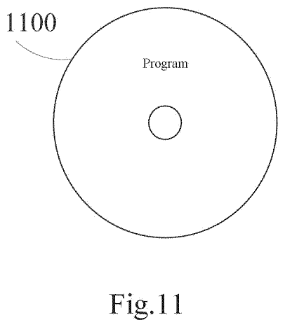

Referring to FIG. 11, a program product 1100 in accordance with an embodiment of the present disclosure for implementing the above method is described. The program product 1100 can adopt a portable compact disk read only memory (CD-ROM) and comprise program codes, and can be run on a terminal device, for example a personal computer. However, the program product according to embodiments of the present disclosure is not limited thereto, and herein, the readable storage medium can be any tangible medium containing or storing a program that can be used in or in connection with an instruction execution system, an apparatus or a device.

The program product can employ any combination of one or more readable media. The readable medium can be a readable signal medium or a readable storage medium. The readable storage medium can be, for example, but not limited to, electronic medium, magnetic medium, optical medium, electromagnetic medium, infrared medium, or semiconductor system, apparatus, or device, or any combination of the above. More specific examples (non-exhaustive lists) of readable storage media comprise: electrical connections with one or more wires, portable disks, hard disks, random access memories (RAMs), read only memories (ROMs), erasable Programmable read-only memories (EPROMs or flash memories), optical fibers, portable compact disk read only memories (CD-ROMs), optical storage devices, magnetic storage devices, or any suitable combination of the foregoing.

The computer readable signal medium can comprise data signals that are in the baseband or propagated as part of a carrier, carrying readable program codes. Such propagated data signals can take a variety of forms comprising, but not limited to, electromagnetic signals, optical signals, or any suitable combination of the foregoing. The readable signal medium can further be any readable medium other than a readable storage medium that can transmit, propagate, or transport a program for use by or in connection with an instruction execution system, an apparatus, or a device.

Program codes carried on a readable medium can be transmitted through any suitable medium, comprising but not limited to wireless, wire, optical cable, RF, etc., or any suitable combination of the foregoing.

Program codes for performing the operations of the present disclosure can be built in any combination of one or more programming languages, comprising an object oriented programming language such as Java, C++, etc., and further comprising conventional procedural programming language—such as the “C” language or a similar programming language. The program codes can be executed completely on a user computing device, partially on a user device, as a stand-alone software package, partially on a remote computing device and partially on the user computing device, or completely on a remote computing device or a server. When a remote computing device is involved, the remote computing device can be connected to the user computing device via any kind of network, comprising a local area network (LAN) or a wide area network (WAN), or can be connected to an external computing device (e.g., via the Internet provided by an Internet service provider).

Further, the above-described drawings are merely illustrative of the processes comprised in the method according to the exemplary embodiments of the present disclosure, and are not intended to be limiting. It is easy to understand that the processing illustrated in the above figures does not designate or limit the chronological order of these processes. In addition, it is also easily understood that these processes can be performed synchronously or asynchronously, for example, in a plurality of modules.

Other embodiments of the disclosure will be apparent to those skilled in the art after reading the specification and practicing the disclosure disclosed here. This application is intended to cover any variations, uses, or adaptations of the disclosure following the general principles thereof and comprising well-known knowledge or commonly used technical means in the art. It is intended that the specification and examples be considered as exemplary only, with a true scope and spirit of the disclosure set forth by the following claims.

1. An article inspection system, comprising:
a pre-concentration sampling module, disposed in a preset range from an article under inspection, and configured to concentrate and sample gas molecules of the article under inspection to capture sample molecules;
a gas chromatography module, connected to the pre-concentration sampling module and configured to pre-separate the sample molecules;
an internal circulation gas path module, connected to the gas chromatography module; and
an ion migration tube module, connected to both the gas chromatography module and the internal circulation gas path module, and configured to inspect a spectrum of the pre-separated sample molecules entering the ion migration tube module from the gas chromatography module, so as to form a fingerprint spectrum of the article under inspection.

2. The article inspection system of claim 1, wherein the pre-concentration sampling module comprises:
a sampling head configured to sample molecules volatilized from the article under inspection;
a solenoid valve configured to control the gas path to be opened or closed;
a filler tube configured to adsorb the volatilized molecules;
a temperature control component configured to control a temperature of the filler tube; and
a sampling pump configured to suction the molecules volatilized from the article under inspection.

3. The article inspection system of claim 1, wherein the gas chromatography module comprises:
a capillary column configured to perform the pre-separation treatment on the sample molecules.

4. The article inspection system of claim 1, wherein the internal circulation gas path module comprises:
a diaphragm pump configured to provide gas circulation power to the internal circulation gas path;
a flow divider configured to divide a gas flow carrying the sample molecules;
a buffer module configured to control fluctuations of the gas flow within a preset range; and
a molecular sieve module configured to purify the gas flow.

5. The article inspection system of claim 1, wherein the internal circulation gas path module comprises:
a second flow divider;
an ion migration tube gas path connected to the second flow divider, comprising a first molecular sieve module and a connecting pipe which are disposed between the second flow divider and the ion migration tube module, wherein gas passes through the ion migration tube gas path so as to enter a drift gas inlet of the ion migration tube module;
a gas chromatography tube gas path connected to the second flow divider and comprising a zero gas carrier gas inlet, a second solenoid valve and a connecting pipe which are disposed between the second flow divider and the gas chromatography module, wherein gas passes through the gas chromatography tube gas path so as to enter the gas chromatography module, wherein the zero gas carrier gas inlet is provided with a second molecular sieve module configured to purify the gas to form zero gas; and
a gas return path connected to the second flow divider and comprising a third diaphragm pump and a connecting pipe which are disposed between the second flow divider and the ion migration tube module, wherein a suction port of the third diaphragm pump is connected to the ion migration tube, and the gas outlet of the third diaphragm pump is connected to the second flow divider.

6. The article inspection system of claim 5, wherein
the ion migration tube gas path further comprises a first buffer module configured to control fluctuation of the gas flow supplied to the ion migration tube module within a preset range; and/or
the gas chromatography tube gas path further comprises a second buffer module configured to control fluctuation of the gas flow supplied to the gas chromatography module within a preset range; and/or
the gas return path further comprises a third buffer module configured to control fluctuation of the gas flow flowing out of the ion migration tube module within a preset range.

7. The article inspection system of claim 5, wherein the ion migration tube gas path further comprises a first flow divider between the first molecular sieve module and the ion migration tube module, wherein gas passing through the first flow divider so as to enter a drift gas inlet and/or air carrier gas inlet of the ion migration tube module.

8. The article inspection system of claim 5, wherein the gas return path further comprises a third flow divider connected to a discharge port of the ion migration tube module.

9. The article inspection system of claim 5, wherein the gas chromatography tube gas path further comprises a second diaphragm pump configured to provide additional gas circulation power to the gas chromatography tube gas path.

10. The article inspection system of claim 5, wherein the gas chromatography tube gas path further comprises a first solenoid valve configured to control the gas path to be opened or closed.

11. The article inspection system of claim 6, wherein:
in the ion migration tube gas path, the first buffer module, the first molecular sieve module, and the first flow divider are sequentially arranged in a direction along which gas moves from the second flow divider to the ion migration tube module, wherein gas passes through the ion migration tube gas path so as to enter the drift gas inlet and the air carrier gas inlet of the ion migration tube module;
in the gas chromatography tube gas path, the second buffer module, the second diaphragm pump, the first solenoid valve, the zero air carrier gas inlet, and the second solenoid valve are sequentially arranged in a direction along which gas moves from the second flow divider to the gas chromatography module; and
in the gas return path, the third flow divider, the third buffer module, and the third diaphragm pump are sequentially arranged in a direction along which gas moves from the ion migration tube module to the second flow divider.

12. The article inspection system of claim 1, wherein the ion migration tube module is a positive and negative dual mode migration tube module, and the positive and negative dual mode migration tube module comprises: a positive mode ionization zone and a negative a mode ionization zone, a positive mode drift zone and a negative mode drift zone, and a positive mode Faraday cup inspection zone and a negative mode Faraday cup inspection zone; wherein the positive mode Faraday cup inspection zone and the negative mode Faraday cup inspection zone are configured to inspect the spectrum of the sample molecules so as to obtain the fingerprint spectrum of the article under inspection.

13. An article inspection system, comprising:
a second flow divider;
an ion migration tube branch connected to the second flow divider, comprising a first buffer module, a first molecular sieve module, an ion migration tube module, and a connecting pipe therebetween, the ion migration tube branch configured to guide gas to pass through the first buffer module, the first molecular sieve module, and to enter a drift gas inlet of the ion migration tube module;
a gas chromatography tube branch connected to the second flow divider and comprising a second buffer module, a second diaphragm pump, a zero gas carrier gas inlet, a gas sampling inlet, a second solenoid valve, a gas chromatography tube module, and a connecting pipe therebetween, the gas chromatography tube branch configured to guide carrier gas to pass through the second buffer module, the first solenoid valve, the zero air carrier gas inlet, and to mix with sample gas from the gas sampling inlet, and then to enter the gas chromatography tube module through the second solenoid valve, wherein a second molecular sieve module is provided at the zero gas carrier gas inlet; and
a gas return branch connected to the second flow divider, comprising the third flow divider, the third buffer module, and the third diaphragm pump and a connecting pipe therebetween, wherein under effect of the third diaphragm pump, gas flows from the ion migration tube module and moves to the third flow divider, the third buffer module, and the third diaphragm pump, and is ultimately suctioned to the second flow divider; the first buffer module, the second buffer module, and the third buffer module are configured to control fluctuation of gas flow within a preset range, and the first molecular sieve module and the second molecular sieve module are configured to purify the gas to form zero gas, the second flow divider and the third flow divider are configured to divide the gas flow, the first diaphragm pump is configured to provide gas circulation power to the entire system, and the second diaphragm pump is configured to provide additional power to flow of gas in the gas chromatography tube branch, and the first solenoid valve and the second solenoid valve are configured to control the gas path to be opened and closed.

14. The article inspection system of claim 13, wherein the ion migration tube branch further comprises a first flow divider; wherein the gas passes sequentially through the first buffer module, the first molecular sieve module, and the first flow divider and ultimately enters the drift gas inlet of the ion migration tube module and/or the air carrier gas inlet of the ion migration tube module.

15. The article inspection system of claim 13, further comprising a dynamic pre-concentration sampling branch, and the dynamic pre-concentration sampling branch comprising:
a sampling head configured to sample molecules volatilized from an article under inspection;
a third solenoid valve configured to control the intake gas path to be opened or closed;
a filler tube disposed between the gas sampling inlet of the gas chromatography tube branch and the second solenoid valve and configured to adsorb the volatilized molecules;
a temperature control component configured to control a temperature of the filler tube for performing adsorption and desorption operations;
a fourth solenoid valve configured to control the gas path to be opened or closed; and
a first diaphragm pump configured to suction the molecules volatilized from the article under inspection;
wherein the dynamic pre-concentration sampling branch is connected to the gas chromatography tube branch through the gas sampling inlet, and the outlet of the filler tube is connected to the second solenoid valve and the fourth solenoid valve.

16. The article inspection system of claim 13, wherein the gas chromatography tube branch further comprises the first solenoid valve between the second diaphragm pump and the zero gas carrier gas inlet and configured to control the gas path to be opened and closed.

17. The article inspection system of claim 13, wherein
the second flow divider is configured such that a ratio of gas flows to the ion migration tube branch and to the gas chromatography tube branch ranges from 3:1 to 20:1.

18. An article inspection method, comprising:
acquiring sample molecules of an article under inspection;
pre-separating the sample molecules of the article under inspection;
forming a fingerprint spectrum of the article under inspection according to a spectrum of the sample molecules; and
identifying a type of the article under inspection from the fingerprint spectrum.

19. The article inspection method of claim 18, wherein identifying a type of the article under inspection from the fingerprint spectrum comprises:
identifying the type of the article under inspection according to a mapping relationship between fingerprint spectrums and articles.

20. The article inspection method of claim 18, wherein acquiring sample molecules of an article under inspection comprises:
performing adsorption treatment on the sample molecules volatilized from the article under inspection through a sampling module, and then heating the sampling module to a preset temperature to perform desorption treatment on the sample molecules.

21-25. (canceled)
